(19) United States
(12) Patent Application Publication
(10) Pub. No.: US 2017/0208533 A1
(43) Pub. Date: Jul. 20, 2017

(54) CONTROLLING COMMUNICATIONS FOR DRIVER CELL PHONE INTERACTIONS IN RESTRICTED AREAS

(71) Applicant: International Business Machines Corporation, Armonk, NY (US)

(72) Inventors: Charla L. Stracener, Argyle, TX (US); Mathews Thomas, Flower Mound, TX (US); Janki Y. Vora, Dallas, TX (US); Jeffery R. Washburn, Justin, TX (US)

(21) Appl. No.: 14/997,856

(22) Filed: Jan. 18, 2016

(51) Int. Cl. H04W 48/04

(52) U.S. Cl. CPC H04W 48/04

(57) ABSTRACT

Controlling safety features for mobile device interactions in restricted areas includes identification, by a processor, of an operator of a vehicle based on at least one of subscriber identity module (SIM) card detection and image recognition. A physical location of mobile devices within the vehicle relative to one another is determined based on SIM card locations of the mobile devices. A physical location of an operator mobile device located in proximity of an operator position in the vehicle is determined based on imaging. The physical location of the operator mobile device is communicated to a cell tower. The processor detects whether the operator mobile device is in use and communicatively interacting with another mobile device. It is determined if the geographical location is in a predefined restricted area for using the operator mobile device, and if so, the operator mobile device communication is controlled.

### BACKGROUND

Users tend to travel with their mobile device to repeated destinations or events (e.g., calendaring events). Although users may naturally repeat their behavior, such as using the same mobile devices, sensors, or apps and parking in the same garage(s), their tendency to perform the same set of actions may not always be the best course for the target destination given circumstances or environmental events that are dynamically changing.

### SUMMARY

Embodiments of the invention relate to controlling vehicle operator mobile device communication in a restricted area. One embodiment includes a computer program product for controlling safety features for mobile device interactions in restricted areas, the computer program product comprising a computer readable storage medium having program instructions embodied therewith, the program instructions executable by a processor to cause the processor to: identify, by a processor, an operator of a vehicle based on at least one of subscriber identity module (SIM) card detection and image recognition to determine operator location within the vehicle. The processor determines a physical location of mobile devices within the vehicle relative to one another based on SIM card locations of the mobile devices. A physical location of an operator mobile device located in proximity of an operator position in the vehicle is identified based on imaging. The physical location of the operator mobile device is communicated to a cell tower. The processor detects whether the operator mobile device is in use and communicatively interacting with another mobile device. A geographical location of the operator mobile device is determined. The processor determines that the geographical location is in a predefined restricted area for using the operator mobile device. Upon determining that the operator mobile device is in the predefined restricted area, communication for the operator mobile device is controlled by de-activating cellular and data service to the operator mobile device except for emergency or non-restricted contact number. The processor automatically notifies the operator mobile device and the another mobile device that the operator mobile device is in the predefined restricted area. The processor further determines that the operator mobile device has left the predefined restricted area and controls the operator mobile device by re-activating cellular and data service to the operator mobile device. The processor additionally notifies the operator mobile device and the another mobile device that the operator mobile device is in a safe zone and provide a query for resuming communications between the operator mobile device and the another mobile device.

These and other features, aspects and advantages of the present invention will become understood with reference to the following description, appended claims and accompanying figures.

### BRIEF DESCRIPTION OF THE DRAWINGS

FIG. 1 depicts a cloud computing environment, according to an embodiment;

FIG. 2 depicts a set of abstraction model layers, according to an embodiment;

FIG. 3 shows a schematic view of a communications system, according to an embodiment;

FIG. 4 shows a block diagram of architecture for a mobile electronic device system, according to an embodiment;

FIG. 5 shows a component interaction diagram for controlling vehicle operator mobile device communication in a restricted area, according to an embodiment;

FIG. 6 shows an example system for controlling vehicle operator mobile device communication in a restricted area, according to an embodiment; and

FIG. 7 illustrates a block diagram for a process for controlling safety features for mobile device interactions in restricted areas, according to one embodiment.

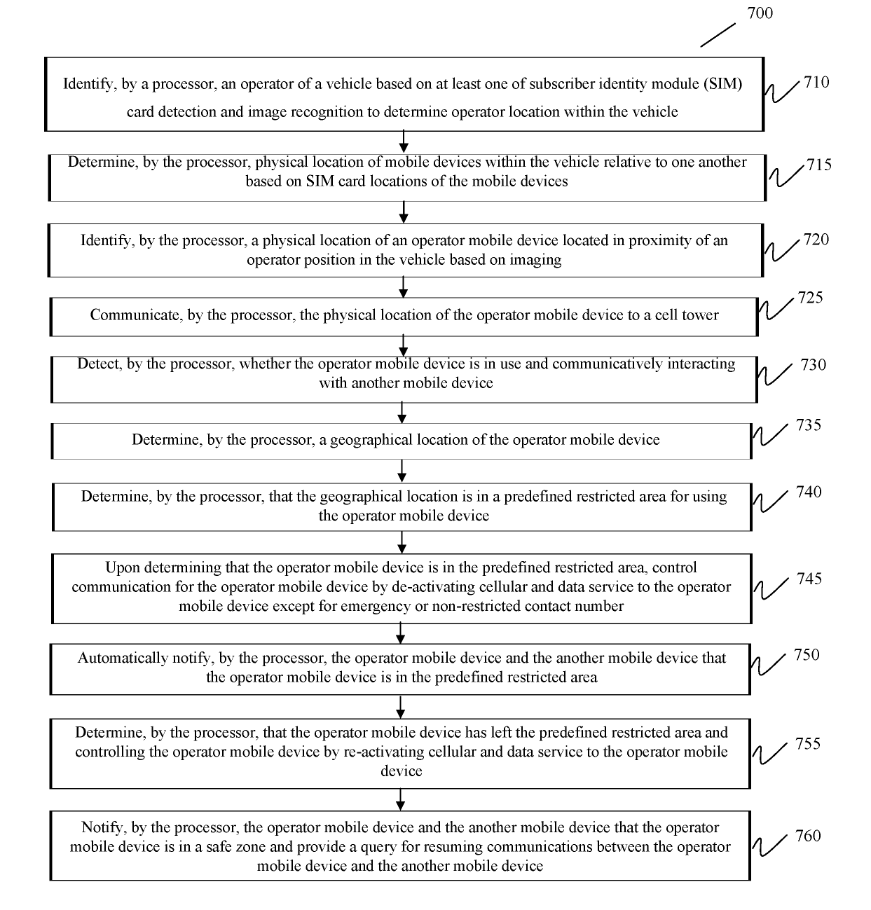

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

One or more embodiments provide for detecting by the telecommunications company (Telco) provider cell phone interaction (data, calls, etc.) that occurs in a given area. If the Telco provider determines that the interaction is dangerous, the cell phone provider can terminate the interaction and resume it when it is safe to do so. The owner of the cell phone may also define what is dangerous through a profile. For example, the owner may set the cell phone profile to “No texting while driving” or “No app usage while driving” or “Only use App X, Y, Z when driving” and the cell phone will be set accordingly. In addition, the profile can be set so that individuals that the user of the phone is interacting with are notified when the cell phone is being used in a dangerous manner so that the second party can decide how to respond.

One or more embodiments are used for controlling communications in restricted areas as described in the following examples. In one example, the driver of a vehicle is talking on a cell phone and approaches a school zone. The cell phone network functions or even the cell phone itself is automatically disabled and reverts back to previous state including resuming the call once the driver gets back to a safe zone. Another example is that a teenage driver attempts to text someone and the recipient of the text is notified that individual is driving and therefore refuses to respond to the message. A further example provides that a driver attempts to text someone or use an app on the phone and the phone moves to disabled state. The driver gives the phone to a passenger and everything resumes to normal. In one or more embodiments, emergency interactions may still occur when the cell phone is in a disabled state so users can call 911 when in a disabled state. In another example, the system notifies a user who is about to make a call that the user is about to go to a dangerous zone so the call will be suspended during the above period and it may make sense to start the call once out of the dangerous zone.

It is understood in advance that although this disclosure includes a detailed description of cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines (VMs), and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed and automatically, without requiring human interaction with the service's provider.

Broad network access: capabilities are available over a network and accessed through standard mechanisms that promote use by heterogeneous, thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned and, in some cases, automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported, thereby providing transparency for both the provider and consumer of the utilized service.

Service Models are as follows:

Software as a Service (SaaS): the capability provided to the consumer is the ability to use the provider's applications running on a cloud infrastructure. The applications are accessible from various client devices through a thin client interface, such as a web browser (e.g., web-based email). The consumer does not manage or control the underlying cloud infrastructure including network, servers, operating systems, storage, or even individual application capabilities, with the possible exception of limited consumer-specific application configuration settings.

Platform as a Service (PaaS): the capability provided to the consumer is the ability to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is the ability to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is a service oriented with a focus on statelessness, low coupling, modularity, and semantic interoperability. At the heart of cloud computing is an infrastructure comprising a network of interconnected nodes.

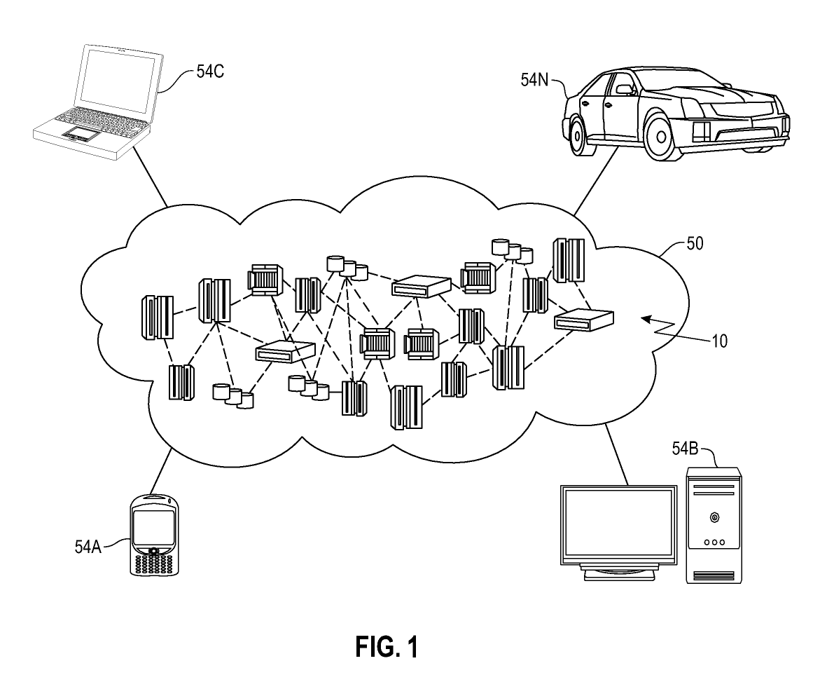

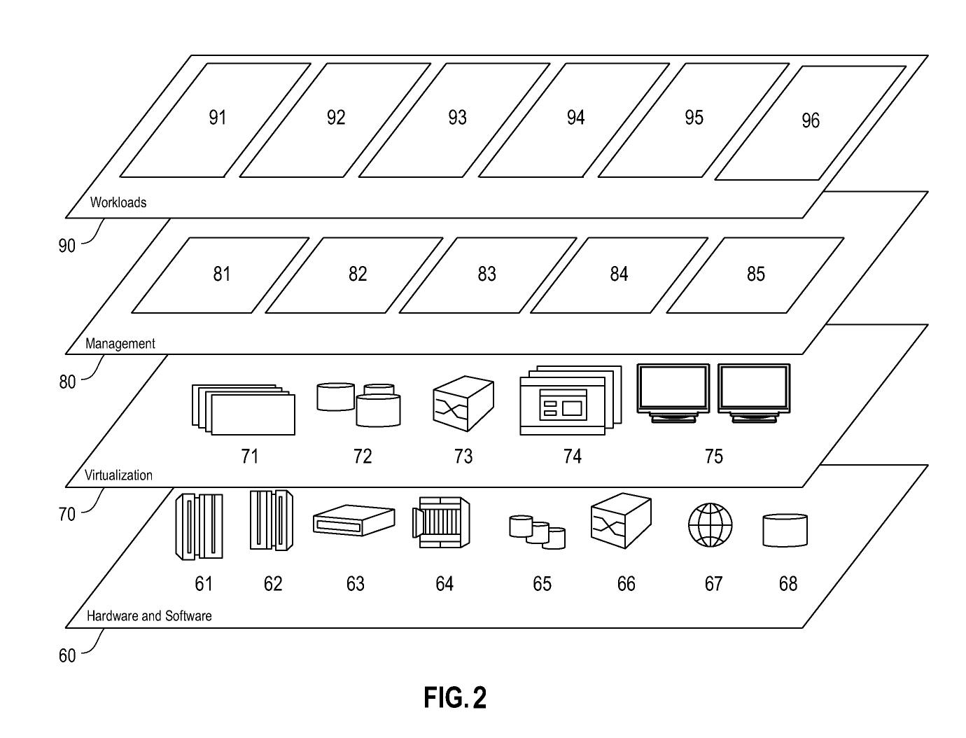

Referring now to FIG. 1, an illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as private, community, public, or hybrid clouds as described hereinabove, or a combination thereof. This allows the cloud computing environment 50 to offer infrastructure, platforms, and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

Referring now to FIG. 2, a set of functional abstraction layers provided by the cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, a management layer 80 may provide the functions described below. Resource provisioning 81 provides dynamic procurement of computing resources and other resources that are utilized to perform tasks within the cloud computing environment. Metering and pricing 82 provide cost tracking as resources are utilized within the cloud computing environment and billing or invoicing for consumption of these resources. In one example, these resources may comprise application software licenses. Security provides identity verification for cloud consumers and tasks as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95 and controlling operator mobile device communication in restricted areas 96. As mentioned above, all of the foregoing examples described with respect to FIG. 2 are illustrative only, and the invention is not limited to these examples.

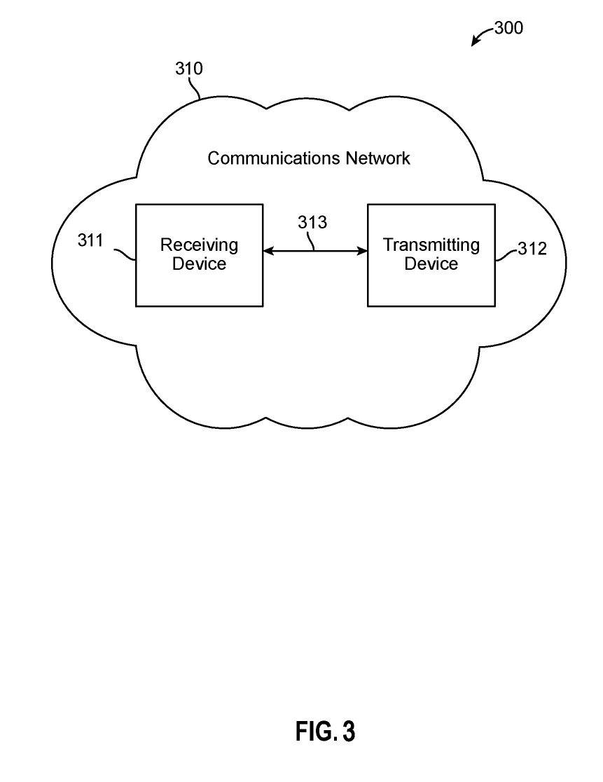

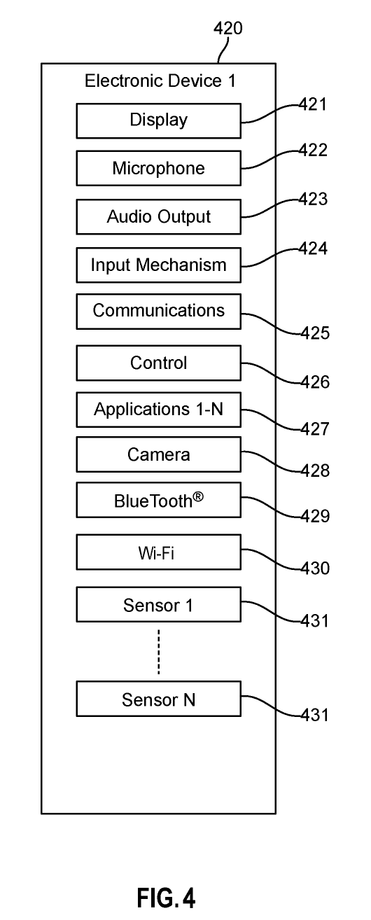

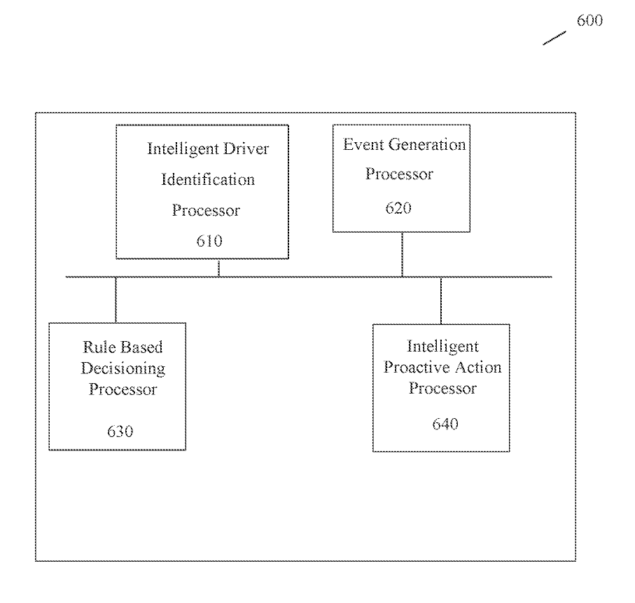

It is understood all functions of one or more embodiments as described herein may be typically performed in the computing environment 50 (FIG. 1), the network 300 (FIG. 3) for the electronic device 420 (FIG. 4), and system 600 (FIG. 6), which can be tangibly embodied as hardware processors and with modules of program code. However, this need not be the case. Rather, the functionality recited herein could be carried out/implemented and/or enabled by any of the layers 60, 70, 80 and 90 shown in FIG. 2.

It is reiterated that although this disclosure includes a detailed description on cloud computing, implementation of the teachings recited herein are not limited to a cloud computing environment. Rather, the embodiments of the present invention may be implemented with any type of clustered computing environment now known or later developed.

FIG. 3 is a schematic view of a communications system 310, in accordance with one embodiment. Communications system 310 may include a communications device that initiates an outgoing communications operation (transmitting device 312) and a communications network 310, which transmitting device 312 may use to initiate and conduct communications operations with other communications devices within communications network 310. For example, communications system 310 may include a communication device (receiving device 311) that receives the communications operation from the transmitting device 312. Although communications system 310 may include multiple transmitting devices 312 and receiving devices 311, only one of each is shown in FIG. 3 to simplify the drawing.

Any suitable circuitry, device, system or combination of these (e.g., a wireless communications infrastructure including communications towers and telecommunications servers) operative to create a communications network may be used to create communications network 310. Communications network 310 may be capable of providing communications using any suitable communications protocol. In some embodiments, communications network 310 may support, for example, traditional telephone lines, cable television, Wi-Fi (e.g., an IEEE 802.11 protocol), BLUETOOTH®, high frequency systems (e.g., 900 MHz, 2.4 GHz, and 5.6 GHz communication systems), infrared, other relatively localized wireless communication protocol, or any combination thereof. In some embodiments, the communications network 310 may support protocols used by wireless and cellular phones and personal email devices. Such protocols may include, for example, GSM, GSM plus EDGE, CDMA, quadband, and other cellular protocols. In another example, a long range communications protocol can include Wi-Fi and protocols for placing or receiving calls using VOIP, LAN, WAN, or other TCP-IP based communication protocols. The transmitting device 12 and receiving device 11, when located within communications network 310, may communicate over a bidirectional communication path such as path 313, or over two unidirectional communication paths. Both the transmitting device 312 and receiving device 311 may be capable of initiating a communications operation and receiving an initiated communications operation.

The transmitting device 312 and receiving device 311 may include any suitable device for sending and receiving communications operations. For example, the transmitting device 312 and receiving device 311 may include mobile telephone devices, television systems, cameras, camcorders, a device with audio video capabilities, tablets, wearable devices, other smart devices, and any other device capable of communicating wirelessly (with or without the aid of a wireless-enabling accessory system) or via wired pathways (e.g., using traditional telephone wires). The communications operations may include any suitable form of communications, including for example, voice communications (e.g., telephone calls), data communications (e.g., e-mails, text messages, media messages), video communication, communications with calendaring applications, or combinations of these (e.g., video conferences).

FIG. 4 shows a functional block diagram of a mobile electronic device 420 that may be controlled when in restrictive areas, according to one embodiment. Both the transmitting device 312 and receiving device 311 may include some or all of the features of the electronics device 420. In one embodiment, the electronic device 420 may comprise a display 421, a microphone 422, an audio output 423, an input mechanism 424, communications circuitry 425, control circuitry 426, Applications 1-N 427 (e.g., a calendaring application), camera 428, a BLUETOOTH® interface 429, a Wi-Fi interface 430 and sensors 1 to N 431 (N being a positive integer) and any other suitable components. In one embodiment, applications 1-N 427 are provided and may be obtained from a cloud or server via a communications network 410, etc., where N is a positive integer equal to or greater than 1.

In one embodiment, all of the applications employed by the audio output 423, the display 421, input mechanism 424, communications circuitry 425, and the microphone 422 may be interconnected and managed by control circuitry 426. In one example, a handheld music player capable of transmitting music to other tuning devices may be incorporated into the electronics device 420.

In one embodiment, the audio output 423 may include any suitable audio component for providing audio to the user of electronics device 420. For example, audio output 423 may include one or more speakers (e.g., mono or stereo speakers) built into the electronics device 420. In some embodiments, the audio output 423 may include an audio component that is remotely coupled to the electronics device 420. For example, the audio output 423 may include a headset, headphones, or earbuds that may be coupled to communications device with a wire (e.g., coupled to electronics device 420 with a jack) or wirelessly (e.g., BLUETOOTH® headphones or a BLUETOOTH® headset).

In one embodiment, the display 421 may include any suitable screen or projection system for providing a display visible to the user. For example, display 421 may include a screen (e.g., an LCD, LED, etc. screen) that is incorporated in the electronics device 420. Display 421 may be operative to display content (e.g., information regarding communications operations or information regarding available media selections) under the direction of control circuitry 426.

In one embodiment, input mechanism 424 may be any suitable mechanism or user interface for providing user inputs or instructions to electronics device 420. Input mechanism 424 may take a variety of forms, such as a button, keypad, dial, a click wheel, or a touch screen. The input mechanism 424 may include a multi-touch screen.

In one embodiment, communications circuitry 425 may be any suitable communications circuitry operative to connect to a communications network (e.g., communications network 110, FIG. 1) and to transmit communications operations and media from the electronics device 420 to other devices within the communications network. Communications circuitry 425 may be operative to interface with the communications network using any suitable communications protocol such as, for example, Wi-Fi (e.g., an IEEE 802.11 protocol), BLUETOOTH®, high frequency systems (e.g., 900 MHz, 2.4 GHz, and 5.6 GHz communication systems), infrared, GSM, GSM plus EDGE, CDMA, quadband, and other cellular protocols, VOIP, TCP-IP, or any other suitable protocol.

In some embodiments, communications circuitry 425 may be operative to create a communications network using any suitable communications protocol. For example, communications circuitry 425 may create a short-range communications network using a short-range communications protocol to connect to other communications devices. For example, communications circuitry 425 may be operative to create a local communications network using the Bluetooth® protocol to couple the electronics device 420 with a BLUETOOTH® headset.

In one embodiment, control circuitry 426 may be operative to control the operations and performance of the electronics device 420. Control circuitry 426 may include, for example, one or more processors, a bus (e.g., for sending instructions to the other components of the electronics device 420), memory, storage, or any other suitable component for controlling the operations of the electronics device 420. In some embodiments, a processor may drive the display and process inputs received from the user interface. The memory and storage may include, for example, cache, Flash memory, ROM, and/or RAM/DRAM. In some embodiments, memory may be specifically dedicated to storing firmware (e.g., for device applications such as an operating system, user interface functions, and processor functions). In some embodiments, memory may be operative to store information related to other devices with which the electronics device 420 performs communications operations (e.g., saving contact information related to communications operations or storing information related to different media types and media items selected by the user).

In one embodiment, the control circuitry 426 may be operative to perform the operations of one or more applications implemented on the electronics device 420. Any suitable number or type of applications may be implemented. Although the following discussion will enumerate different applications, it will be understood that some or all of the applications may be combined into one or more applications. For example, the electronics device 420 may include a calendaring application (e.g., MICROSOFT® OUTLOOK®, GOOGLE® Calendar, etc.), an automatic speech recognition (ASR) application, a dialog application, a map application, a media application (e.g., QuickTime, MobileMusic.app, or MobileVideo.app), social networking applications (e.g., FACEBOOK®, TWITTER®, INSTAGRAM®, etc.), an Internet browsing application, etc. In some embodiments, the electronics device 420 may include one or multiple applications operative to perform communications operations. For example, the electronics device 420 may include a messaging application, a mail application, a voicemail application, an instant messaging application (e.g., for chatting), a videoconferencing application, a fax application, or any other suitable applications for performing any suitable communications operation.

In some embodiments, the electronics device 420 may include a microphone 422. For example, electronics device 420 may include microphone 422 to allow the user to transmit audio (e.g., voice audio) for speech control and navigation of applications 1-N 427, during a communications operation or as a means of establishing a communications operation or as an alternative to using a physical user interface. The microphone 422 may be incorporated in the electronics device 420, or may be remotely coupled to the electronics device 420. For example, the microphone 422 may be incorporated in wired headphones, the microphone 422 may be incorporated in a wireless headset, the microphone 422 may be incorporated in a remote control device, etc.

In one embodiment, the camera 428 comprises one or more camera devices that include functionality for capturing still and video images, editing functionality, communication interoperability for sending, sharing, etc., photos/videos, etc.

In one embodiment, the BLUETOOTH® interface 429 comprises processes and/or programs for processing BLUETOOTH® information, and may include a receiver, transmitter, transceiver, etc.

In one embodiment, the electronics device 420 may include multiple sensors 1 to N 431, such as accelerometer, gyroscope, microphone, temperature, light, barometer, magnetometer, compass, radio frequency (RF) identification sensor, global positioning system (GPS), Wi-Fi, alcohol, etc. In one embodiment, the multiple sensors 1-N 431 may be aggregated or used from different electronic devices, such as an electronic device 420 (e.g., a smartphone) and another electronic device 420 (e.g., a wearable device such as a smartwatch). For example, a gyroscope sensor and/or a temperature may be used from a wearable device, and a microphone sensor may be used from a smartphone.

In one embodiment, the electronics device 420 may include any other component suitable for performing a communications operation. For example, the electronics device 420 may include a power supply, ports, or interfaces for coupling to a host device, a secondary input mechanism (e.g., an ON/OFF switch), or any other suitable component.

One or more embodiments provide for the ability to determine who the driver is and correlating this with the mobile electronic device 420 of the driver to ensure safety rules as defined in the profile or laws are adhered to. In one embodiment, processing is provided for determining who the driver is using image recognition from the camera 428 or triangulation across SIM cards within the vehicle. A local cell tower may automatically place electronic devices 420 in a disabled state unless it is emergency or restricted number. A party (or parties) interacting with an electronic device 420 owner may be notified (e.g., a text message, a call group chat, etc.) when an electronic device 420 is being used dangerously so that the second party can decide how to respond. In one example, the system provides for the ability to resume interaction automatically when an electronic device 420 is in a safe zone (e.g., not in a driver position). In one embodiment, the system provides for a “suspended interaction” where the interaction is held in limbo until all participants are in a safe location as defined by profiles or local laws. Once in a safe zone, the previous interaction continues as normal. In one example, the system provides for extending and suspending interaction to include automatic reconnections of dropped calls when in danger zone or otherwise. One embodiment provides for identification of patterns in order to proactively determine if a device will be entering a dangerous zone or leaving a dangerous zone and responds accordingly.

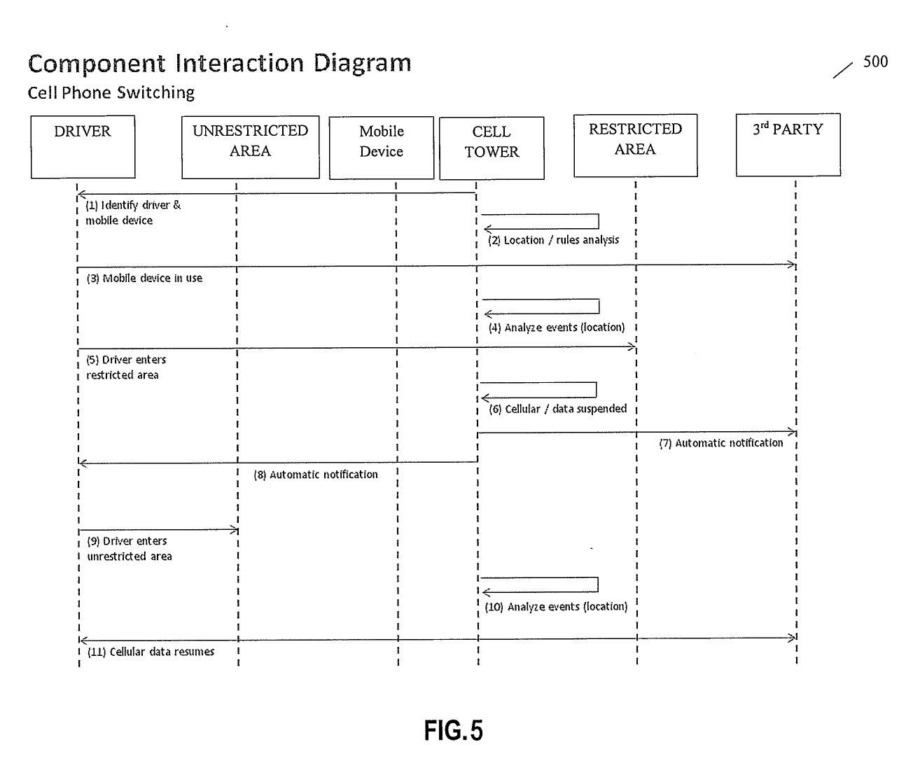

FIG. 5 shows a component interaction diagram 500 for controlling vehicle operator mobile device communication in a restricted area, according to an embodiment. In one embodiment, the driver and driver's mobile device (e.g., an electronic device 420, FIG. 4) is identified. In one example, identification may be accomplished using “Best Buddies”—the driver of the vehicle can be identified by the cell tower based on the physical location within the car of each mobile device SIM card, if multiple SIM cards are detected. If a single SIM card is detected in the vehicle, it is assumed to be the driver. In another example, identification may be accomplished using image recognition—the driver of the vehicle may be identified by the interconnected vehicle using image recognition (e.g., using an electronic device 420 camera 428) to determine if a given mobile device is being used while in the driver's seat of the vehicle. In one example, recognition of the seat placement, steering wheel, mirrors, etc. may be used.

In one embodiment, the physical location of mobile devices, relative to each other within the vehicle, are identified by the cell tower based on SIM card(s) that are physically present. The driver can be identified based on the physical location within the vehicle relative to other SIM card locations. The physical location of the mobile device in the vehicle is identified by image recognition and communicated to the local cell tower only if the mobile device is located in the proximity of the driver's seat.

In one embodiment, the system (e.g., system 600, FIG. 6) uses a cell tower to determine that a mobile device is in use based on interactions with another party. In one example, if it is determined that the driver of the vehicle is using a mobile device, the geographical location of the mobile device is identified by the cell tower. The local cell tower determines if the vehicle is in a predefined restricted area. The restricted area may be a school zone, an emergency zone, an entire state, etc.

In one embodiment, when the mobile device is determined to be in use by the driver of the vehicle, the local cell tower automatically places the mobile device in a disabled state unless it is an emergency (e.g., dialing or texting 911) or restricted number. The party (or parties) interacting with the device owner is notified (e.g., via text message, a call group chat, voice message, etc.) when an operator/driver of a vehicle is using a mobile device dangerously so that the other party can decide how to respond.

In one embodiment, the driver or operator is notified when a mobile device is being used dangerously and the mobile device interaction(s) are suspended. In one example, since communicating with the driver could be a liability, a voice message to the driver stating that interactions have been suspended due to being in a restricted area may be made. In one or more embodiments, the local cell tower determines when the vehicle leaves a restricted area. In one example, the system analyzes events (location)—the geographical location of the mobile device of the driver is once again identified by the cell tower. When it is determined that the vehicle is in a safe zone, cellular and data capabilities for the mobile device are enabled. The driver and the third party of the suspended interaction(s) are notified once in a safe zone and can determine if they would like to resume the previously suspended interaction.

FIG. 6 shows an example system 600 for controlling vehicle operator mobile device communication in a restricted area, according to an embodiment. In one embodiment, system 600 includes an intelligent driver identification processor 610, an event generation processor 620, a rule based decisioning processor 630 and an intelligent proactive action processor 640. In one embodiment, the intelligent driver identification processor 610 may be a thin or a thick client or may be deployed as a service. In one example, the intelligent driver identification processor 610 identifies the driver and the device the driver is handling dynamically. The intelligent driver identification processor 610 enables notification to the service provider about the information of the device being used by driver entity. In one example the driver manually inputs the mobile device (e.g., electronic device 420, FIG. 4) to be in a driver use mode. In another example, based on sensors deployed in the mobile device (e.g., a camera, bioinformatics information such as fingerprint recognition may be combined), and based on an individual's action or fingerprint captured from a steering wheel may be correlated with the mobile device in use and identify the driver and the device. In real time the intelligent driver identification processor 610 based on sensor collected data correlation places the mobile device in driver mode and notifies the service provider about the details. In another example, the intelligent driver identification processor 610 leverages coordinate triangulation co-related to the SIM card in a smart car to identify the relative position of the driver and take appropriate actions of identifying the driver and the device in near real time.

In one embodiment, the event generation processor 620 is constantly collecting information such as latitude, longitude, timestamp, alcohol level (e.g., using an alcohol sensor 431, FIG. 4), users attention level. The event generation processor 620 uses the events to create alerts to be sent to the rule based decisioning processor 630. For instance, each time a no cell phone zone is entered an event is generated. The event generation processor 620 generates N event when a driver is determined to be driving above speed limits, in an inattentive mode, when alcohol level is determined above normal, etc. or other events may be configured.

In one embodiment, the rule based decisioning processor 630 determines if the event needs to trigger an action. For instance, in some states texting is restricted, but handheld calling is allowed. In some states there are age restrictions that forbid teenage drivers from texting or calling at all times. The rule based decisioning processor 630 determines a next best action. In one example, the rule based decisioning processor 630 communicates the action to the service provider and/or manages the mobile device settings appropriately.

In one embodiment, the intelligent proactive action processor 640 may be managed at the device level and or at the service provider level. In one example, the service provider may be notified of the restrictive zone and places the existing call in a hold mode, notifies the end user of the unavailability and re-connects once the restriction is eliminated. In another example the intelligent proactive action processor 640 may alert the recipient of the text that the message is received from the user who is in a drive mode. A variety of actions are managed and are configurable at this level.

FIG. 6 illustrates a block diagram for a process 700 for controlling safety features for mobile device interactions in restricted areas, according to one embodiment. In one embodiment, in block 710 a processor is used for identifying an operator of a vehicle based on at least one of SIM card detection and image recognition to determine operator location within the vehicle. In block 715 the processor is used to determine physical location of mobile devices within the vehicle relative to one another based on SIM card locations of the mobile devices. In block 720 the processor identifies a physical location of an operator mobile device located in proximity of an operator position in the vehicle based on imaging. In block 725 the processor communicates the physical location of the operator mobile device to a cell tower. In block 730 the processor detects whether the operator mobile device is in use and communicatively interacting with another mobile device. In block 735 the processor determines a geographical location of the operator mobile device. In block 740 the processor determines that the geographical location is in a predefined restricted area for using the operator mobile device. In block 745, upon determining that the operator mobile device is in the predefined restricted area, control communication for the operator mobile device by de-activating cellular and data service to the operator mobile device except for emergency or non-restricted contact number. In block 750 the processor automatically notifies the operator mobile device and the another mobile device that the operator mobile device is in the predefined restricted area. In block 755 the processor determines that the operator mobile device has left the predefined restricted area and controlling the operator mobile device by re-activating cellular and data service to the operator mobile device. In block 760 the processor notifies the operator mobile device and the another mobile device that the operator mobile device is in a safe zone and provide a query for resuming communications between the operator mobile device and the another mobile device.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer program product for controlling safety features for mobile device interactions in restricted areas, the computer program product comprising a non-transitory computer readable storage medium having program instructions embodied therewith, the program instructions executable by a processor to cause the processor to:
identify, by a processor, an operator of a vehicle based on at least one of triangulation across subscriber identity module (SIM) cards to determine operator location within the vehicle;
determine, by the processor, physical location of mobile devices within the vehicle relative to one another based on SIM card locations of the mobile devices;
identify, by the processor, a physical location of an operator mobile device located in proximity of an operator position in the vehicle based on imaging;
communicate, by the processor, the physical location of the operator mobile device to a local cell tower;
detect, by the local cell tower, whether the operator mobile device is in use and communicatively interacting with another mobile device;
determine, by the local cell tower, a geographical location of the operator mobile device;
determine, by the local cell tower, that the geographical location is in a predefined restricted area for using the operator mobile device;
upon determining that the operator mobile device is in the predefined restricted area, control communication for the operator mobile device by and at the local cell tower by de-activating cellular and data service by and at the local cell tower to the operator mobile device except for emergency or non-restricted contact number;
automatically notify, by the processor, the operator mobile device and the another mobile device that the operator mobile device is in the predefined restricted area;
upon determining by the local cell tower that the operator mobile device has left the predefined restricted area, controlling the operator mobile device by re-activating cellular and data service to the operator mobile device by and at the local cell tower; and
notify, by the processor, the operator mobile device and the another mobile device that the operator mobile device is in a safe zone and provide a query for resuming communications between the operator mobile device and the another mobile device.
